(19) United States
(12) Patent Application Publication
(10) Pub. No.: US 2013/0298946 A1
(43) Pub. Date: Nov. 14, 2013

(54) PRETREATMENT COMPOSITION AND METHOD

(71) Applicant: Innovation Services, Inc., Knoxville, TN (US)

(72) Inventor: Jeffrey G. Hubrig, Knoxville, TN (US)

(21) Appl. No.: 13/946,625

(22) Filed: Jul. 19, 2013

Related U.S. Application Data
(63) Continuation-in-part of application No. 12/869,183, filed on Aug. 26, 2010.
Application No. 12/869,183 is a continuation-in-part of application No. 11/697,933, filed on Apr. 9, 2007, now Pat. No. 7,799,234.
Application No. 11/697,933 is a continuation-in-part of application No. 11/697,921, filed on Apr. 9, 2007, now Pat. No. 7,794,606.

(51) Int. Cl. C02F 1/68

(52) U.S. Cl. CPC C02F 1/682
USPC 134/22.19; 210/696; 210/698; 510/161

(57) ABSTRACT

A medical waste pretreatment and/or conditioner composition comprising a lipid agglomeration inhibitor and a surfactant having an HLB value ranging from about 1 to less than about 5, wherein a weight ratio of agglomeration inhibitor to surfactant on 100 wt. % active ingredient basis ranges from about 0.015:1 to about 3:1.

### RELATED APPLICATIONS

This application is a continuation-in-part of co-pending application Ser. No. 12/869,183, filed Aug. 26, 2010, which is a continuation-in-part of U.S. Pat. No. 7,799,234 issued Sep. 21, 2010 and U.S. Pat. No. 7,794,606 issued Sep. 14, 2010.

### FIELD OF THE DISCLOSURE

The present disclosure is generally directed toward compositions and methods for pretreating and conditioning fluid medical waste streams to maintain the cleanliness of wetted contact surface areas exposed to the waste streams during waste stream treatment system processing. The compositions and methods may be used for a wide variety of medical waste surface conditioning, pretreating and/or cleaning.

### BACKGROUND AND SUMMARY

Hospitals, surgery centers and other medical treatment facilities are among many source point generators of fluid medical waste streams, which are collected from surgical operations and other treatment procedures. The medical waste streams are typically immediately discharged from their respective collection systems as untreated waste into municipal sewer systems and landfills. The immediate disposal of these collected and untreated fluid medical waste streams avoids having to manage bulk volumes of collected fluid medical waste streams which must be managed for any subsequent processing through a fluid medical waste treatment system.

Typical bulk volumes of fluid medical waste streams contain lipid, protein and other constituent complexes which may undergo time/temperature dependent phase changes. Bulk volume phase changes in the waste streams are capable of producing lipid agglomerations and protein cascades that can alter waste stream fluid flow properties sufficiently to inhibit or prevent the efficacy of a fluid flow medical waste treatment system. In addition to bulk volume phase changes, lipid complexes aggressively bond to wetted contact surface areas and provide an organic primer for the subsequent bonding of protein complexes to form noxious bio-film soil layers on exposed wetted contact surfaces. Successive contact surface exposure to fluid medical waste streams leads to both increased bio-film thickness and a dry and hardened adhesive bond line between the bio-film layer and the fluid contacted surface.

The potential for fluid medical waste streams to undergo bulk volume phase changes and create bio-film formations on fluid flow contact surfaces is not addressed in current medical waste disposal practices and must be prevented to preserve the efficacy of a fluid medical waste treatment system. Despite the variety of cleaning compositions currently available, there remains a need for a fluid medical waste treatment composition that will pretreat and/or condition the waste stream to prevent bulk volume phase change and lipid adhesion to wetted surfaces in order to assure that fluid flow and processing of the waste stream in a medical waste treatment system remains uninterrupted. It is also desirable that the pretreatment conditioner composition be relatively environmentally friendly so direct discharge of the treated fluid medical waste stream to the environment does not create additional hazards associated with the pretreatment conditioner composition.

With regard to the foregoing needs, the disclosure provides a medical waste pretreatment and/or conditioner composition comprising a lipid agglomeration inhibitor and a surfactant having an HLB value ranging from about 1 to less than about 5, wherein a weight ratio of agglomeration inhibitor to surfactant on 100 wt. % active basis ranges from about 0.015:1 to about 3:1.

Another embodiment of the disclosure provides a method for pretreating and/or conditioning a medical waste stream on a batch or continuous basis. The method includes injecting into the waste stream a composition containing a lipid agglomeration inhibitor and a surfactant having an HLB value ranging from about 1 to less than about 5. A weight ratio of agglomeration inhibitor to surfactant on 100 wt. % active basis ranges from about 0.015:1 to about 3:1. The composition is turbulently mixed with the waste stream and is provided in an amount sufficient to provide from about 0.1 to about 9 weight percent of composition to the waste stream based on a total weight of composition and waste stream.

An advantage of the compositions and methods described herein is that the compositions are not highly corrosive, and do not rely on the use of enzymatic agents which are highly sensitive to alkaline or acid components used in conventional cleaning solutions and to rinse water temperatures. The compositions described herein require only a single HLB range non-ionic surfactant and are effective for preventing the agglomeration of lipid components of the waste stream on hard surfaces and preventing protein components in the waste stream from cascading over time to form odorous gel-like masses on the hard surfaces. Conventional cleaning solutions may be effective for removing either waste protein structures or waste lipid structures from hard surfaces, but may not be effective on both. Furthermore, conventional cleaning solution composition chemistries are dependent on contact immersion time, temperature and concentration level to remove either lipid or protein complexes from hard surfaces. Such key processing parameters for cleaning render conventional compositions ineffective as a pretreatment and/or conditioning agent to prevent either lipid agglomeration or protein cascade in the treatment of bulk volumes of a fluid medical waste stream. However, the compositions described in more detail herein may be effective as a pretreatment and/or conditioning agent for both protein-based and lipid-based components of a waste stream to prevent attachment and agglomeration of lipid and protein components on a surface. While not desiring to be bound by theoretical considerations, it is believed that the lipid agglomeration inhibitor solution is effective to inactivate the lipid components so that the lipid components cannot agglomerate with each other or on hard surfaces to provide sites for protein cascading on the surfaces.

Another advantage of the compositions described herein is that the foaming tendency of the lipid agglomeration inhibitor solution is substantially suppressed by the surfactant and/or lipids in the waste stream so that the composition can be injected into to a flowing stream and/or turbulently mixed with the stream without causing foam that inhibits the effectiveness of the composition. Accordingly, the composition may be injected into a waste stream using an injection nozzle, spray nozzle, or used in a similar injection process where fluidic turbulence is a key processing parameter without the need to include a separate antifoam agent in the composition. Other advantages may be apparent from the following detailed description.

### BRIEF DESCRIPTION OF THE DRAWINGS

FIG. 1 is a photograph of a waste stream that may contain lipid and protein components that agglomerate into larger particles over time.

FIG. 2 is a photograph of a plate that has contacted the waste stream of FIG. 3.

FIG. 3 is a photograph of a plate that has contacted a pretreated waste stream according to an embodiment of the disclosure.

FIG. 4 is a schematic flow diagram of a medical waste system using a pretreatment composition according to an embodiment of the disclosure.

FIG. 5 is a schematic flow diagram of an alternative injection process using a composition according to an embodiment of the disclosure.

### DETAILED DESCRIPTION OF EXEMPLARY EMBODIMENTS

Pretreatment and conditioning compositions, as provided herein, include two important components that may be combined together as a pretreatment conditioner concentrate and/or diluted with water. The two major components include a lipid agglomeration inhibitor solution and a nonionic alkoxylated alcohol surfactant. Optional components of the composition may include one or more of a pH buffering agent, a biocide, a disinfection agent, a sterilization agent, a dye, a chelating agent, and the like. The compositions described herein are particularly suitable for managing medical waste streams and preserving the cleanliness of fluid flow contact surfaces.

Bio-films are contaminants that attach to surfaces of medical equipment, for example, waste medical management or treatment systems. Such films may include lipophilic substances such as fatty organic compounds. Residues from surgical operations include components such as blood, fat, tissue, bone, fecal materials, and surgical rinse solutions having lipophilic components. Such lipophilic substances typically have an affinity for metal and polymeric surfaces and may provide a medium for attachment of protein molecules and bacteria to such surfaces. Once attached to the surface of such equipment, and to fluid flow contact surfaces of a treatment system, cleaning of the soiled surfaces is extremely difficult and may be inhibited by design configurations. However, the compositions described herein may be effective to prevent attachment of lipids and proteins to hard surfaces and may provide foam inhibited compositions for alternative injection processes wherein foaming as a result of fluidic turbulence must be managed.

The composition described herein may be readily rinsed from the fluid flow contact surfaces using water, thus simplifying the number and variety of cleaning compositions needed to assure that the surfaces are substantially free of detectible traces of lipid and/or protein components.

A first component of the compositions described herein is a lipid complex agglomeration inhibitor solution. The agglomeration inhibitor solution is typically provided as a 30 wt. % solution of active ingredient. By “active ingredient,” is meant the chemical compound that is dissolved in a suitable solvent in order to provide the agglomeration inhibitor solution. Other solutions may be used that contain from 10 to about 50 wt. % or more of active ingredient. Accordingly, various aspects of the compositions will be discussed in terms of 100 wt. % active ingredients since the concentration of the lipid complex agglomeration inhibitor in the inhibitor solution may vary depending on the source of the inhibitor.

Suitable agglomeration inhibitor compounds may be selected from alkyl ether sulfates. Alkyl ether sulfates that may be used, include but are not limited to, sodium coconut alkyl sulfate, potassium coconut alkyl sulfate, potassium lauryl sulfate, sodium lauryl sulfate, sodium yellow fatty alcohol ether sulfate, tallow fatty alcohol sulfate (25 ethylene oxide), tallow fatty ether sulfate, sodium dodecyl benzene sulfonate, sodium stearyl sulfate, sodium palmityl sulfate, sodium decyl sulfate, sodium myristyl sulfate, sodium dodecyl sulfate, potassium dodecyl benzene sulfonate, potassium stearyl sulfate, potassium palmityl sulfate, potassium decyl sulfate, potassium myristyl sulfate, potassium dodecyl sulfate, and mixtures thereof.

Other examples of lipid agglomeration inhibitor compounds that may be used are sodium lauryl ether sulfate, ammonium lauryl sulfate, ammonium lauryl ether sulfate, sophorose biosurfactant, sodium lauroyl sarcosinate, triethanolamine lauroyl-L-glutamate, sodium myristyl sarcosinate, potassium laurate, sodium dodecane sulfonates, and sodium lauryl ethoxysulfate.

Without desiring to be bound by theoretical considerations, it is believed that the lipid agglomeration inhibitor in the inhibitor solution may react with lipid components in the waste stream to begin breaking down and denaturing both lipid and protein complexes present in the waste stream. Such reaction may inactivate active sites of the lipids thus preventing agglomeration of the lipids and attraction of protein components in the waste stream. The agglomeration inhibitor may also interact with an existing bio-film layer on the fluid flow wetted contact surface areas of medical of the treatment system through absorption and permeation to induce molecular cleavage within the bio-film structure so as to initiate adhesive failure at a boundary layer between the bio-film structure and wetted contact substrate surface. Once adhesion failure is induced by the agglomeration inhibitor, waste materials on the wetted contact surfaces may be washed away by fluidic turbulence.

A particularly useful lipid agglomeration inhibitor compound for the compositions described herein is sodium lauryl sulfate (SLS). SLS is often referred to as an anionic surfactant. However, in the compositions described herein, SLS has more of a detergent effect. The compositions described herein may contain an amount of SLS, on an active ingredient basis, that is effective to promote solubilization and mobilization of protein and lipid structures, thereby preventing adhesion and enhancing removal of the bio-film from wetted contact surfaces. Accordingly, the amount of agglomeration inhibitor solution in the compositions described herein may range from about 0.25 to about 10 percent by volume based on a total volume of waste material or waste stream based on a 30 wt. % active solution of agglomeration inhibitor. A typical pretreatment or conditioner solution may contain from about 0.5 to about 8 percent by volume of the agglomeration inhibitor solution (30 wt. % active) based on a total volume of the waste material or waste stream. Other useful amounts of agglomeration inhibitor solution may range from 1 to about 3 percent by volume (30 wt. % active) based on a total volume of the waste material or waste stream undergoing the pretreatment or conditioning process.

The second important component of the compositions described herein is a nonionic surfactant having a relatively low hydrophilic: lipophilic balance (HLB) value. The “hydrophilic: lipophilic balance”, or “HLB” value is used as a measure of the relative affinities of the surfactants for water and lipophilic or “oily” substances respectively and correlates with their effectiveness as emulsifiers. HLB values may be calculated for alcohol ethoxylates since it is one fifth of the weight percent of ethylene oxide based on the total mole weight of the compound. Other surfactants may be assigned equivalent values by applying more complicated formulae or by measuring their relative affinity for water and oil. An HLB value of 20 represents a completely water soluble, oil insoluble surfactant, while an HLB value of 0 represents a completely oil soluble, and water insoluble surfactant.

The nonionic surfactants which may be used may be selected from linear and branched alkoxylated alcohols. Still further illustrative examples of nonionic surfactants include primary and secondary linear and branched alcohol ethoxylates, such as those based on C₆ to C₁₈ alcohols which further include an average of from 1 to 80 moles of ethoxylation per mol of alcohol.

Further examples of useful nonionic surfactants include secondary C₁₂ to C₁₈ alcohol ethoxylates, including those which have from about 3 to about 10 moles of ethoxylation. Further exemplary nonionic surfactants include linear primary C₁₁ to C₁₅ alcohol ethoxylates, including those which have from about 3 to about 10 moles of ethoxylation. Other surfactants include linear C₁₁ alcohol with 1 mole (average) of ethylene oxide. Examples include polyoxyethylene(2)cetylether and polyoxyetylene(2)oleylether.

Other examples of useful nonionic surfactants include polyethylene-block poly(ethylene glycol) surfactants having an number average molecular weight of about 875 and an HLB of 4; poly(ethylene glycol)-block poly(propylene glycol)-block-polyethylene glycol) copolymers having number average molecular weights ranging from about 1100 to about 3500 and having HLB values ranging from about 1 to less than about 5.

Still other non-ionic surfactants which may be used include: fatty acid monoalkylolamide ethoxylates, fatty amine alkoxylates and fatty acid glyceryl ester ethoxylates. Other non-ionic compounds suitable for inclusion in compositions of the disclosed embodiments include mixed ethylene oxide propylene oxide block copolymers, low relative molecular mass polyethylene glycols, ethylene glycol monoesters, amine oxides and alkyl polyglycosides, alkyl sugar esters including alkyl sucrose esters and alkyl oligosaccharide ester, alkyl capped polyvinyl alcohol and alkyl capped polyvinyl pyrrolidone.

Of the foregoing nonionic surfactants, one or more ethoxylated linear or branched alcohol nonionic surfactant having an HLB value ranging from about 1 to less than about 5 may provide the most suitable foam inhibiting effects in combination with the biofilm inhibitor. Accordingly, the surfactant may be a single surfactant with an HLB in the range of from about 1 to less than about 5, such as from 1 to about 4 or from 1 to about 3, or a combination of surfactants having the same HLB range may be used. The amount of nonionic surfactant relative to the amount of agglomeration inhibitor solution on a volume ratio basis in the compositions described herein may range 1:3 to about 10:1. For example, pretreatment and/or conditioner compositions may include a volume ratio of surfactant to agglomeration inhibitor solution of from about 1:0.05 to about 9:1 or from about 1:2 to about 5:1, such as from about 1:2 to about 3:1. For the purposes of this disclosure, all references to the nonionic surfactant is with respect to a surfactant that is 100 wt. % active ingredient.

An optional component of the compositions described herein is an aqueous solvent, such as water. The compositions described herein may typically contain a major amount of water. Accordingly, the compositions may contain from about 50 to about 99.9 volume percent water. For example, the compositions from about 60 to about 95 volume percent water. Other compositions may include from about 75 to about 90 volume percent water. Solubilizing agents may be included in the compositions to aid in solubilizing the components of the composition. For example, concentrates containing the surfactants and agglomeration inhibitor may require dispersing or solubilizing agents to provide uniform solution concentrates that may be diluted upon use to provide the pretreatment and conditioning. Such solubilizing or dispersing agents may include, but are not limited to, alcohols, glycols, glycerines, and the like. The amount of solubilizing or dispersing agent in the compositions described herein may range from about 2 to about 10 percent by volume based on the total volume of the concentrate.

Other components which may be present in the compositions described herein may include but are not limited to pH adjustment agents, biocides, bacteriacides, sterilization agents, antifungal agents, germicides, dyes, chelating agents, and the like.

The major components of the compositions described herein may promote a pH that is slightly acidic to neutral. However, the compositions may be more effective for the pretreatment and conditioning applications described herein if the compositions are slightly alkaline. According, a pH adjustment agent may be added to the composition to provide a pH in the range of from about 6.5 to about 10.0. A more desirable pH of the compositions described herein may range from about 8.5 to about 9.5.

A suitable pH adjustment agent may be selected from weak bases such as, ammonium hydroxide, 2-aminopropanoic acid, ammonia, magnesium hydroxide, methylamine, ethylamine, dimethylamine, trimethylamine, pyridine, glycine, hydrazine, and the like. Accordingly, compositions as describe herein may include from about 0.01 to about 1.0 percent by weight of the pH adjustment agent based on a total weight of the composition. Rinse and soak solution concentrates may contain from about 0.01 to about 0.5 weight percent of the pH adjustment agent.

An advantage of the compositions described herein is the compositions do not require the addition of antifoam agents. A lipid agglomeration inhibitor compound such as SLS tends to foam excessively under turbulent conditions in an aqueous stream. However, use of a sufficient amount of surfactant having an HLB value of from about 1 to less than 5 provides sufficient foam inhibition in a turbulent aqueous stream whether the aqueous waste stream contains lipids or not. Accordingly, the combination of agglomeration inhibitor and surfactant may be used in a flowing stream under extremely turbulent conditions or with spray nozzles without excessive foam generation enabling the composition to be turbulently mixed with a waste stream or sprayed into a fluid medical waste treatment system. Waste streams that contain lipid components may further inhibit the foaming tendencies of the lipid agglomeration inhibitor compound.

With regard to compositions containing the lipid agglomeration solution (LAS) and the surfactant component described above, the ranges listed in Table 1 may be used to treat medical waste materials and/or medical waste streams. Higher ratios of LAS to surfactant (Compositions 1-4) may be used where turbulence and the generation of foam are minimal and where the lipid concentration in a waste stream is relatively high. By contrast, Compositions 6-10 may be used where the lipid concentration is relatively low and/or where turbulence and foaming are problematic with regard to adequate cleaning. For example, Composition 1 having a weight ratio of LAS to surfactant of about 2.7:1 on a 100 wt. % active basis may be injected in a waste stream having a relatively high lipid content in order to minimize or eliminate lipid attachment to wetted surfaces in the waste treatment system. Composition 10, having a weight ratio of LAS to surfactant of about 0.016:1 on a 100 wt. % active basis, may be used to treat, pretreat, or clean surfaces containing dried blood or other medical waste materials such as ocular fluids and the like and having extremely low lipid content. Selection of compositions between Compositions 1 and 10 may be made for particular applications depending on treatment conditions that may cause foaming and waste stream lipid content.

TABLE 1

| | Lipid | | LAS |
|---|---|---|---|
| | Agglomeration | | (100 wt. % active)/ |
| | Solution (LAS), | Surfactant, | Surfactant (100 |
| Composition | 30 wt. % active | 100 wt. % active | wt. % active) |
| 1 | 90 | 10 | 2.7 |
| 2 | 80 | 20 | 1.2 |
| 3 | 70 | 30 | 0.7 |
| 4 | 60 | 40 | 0.45 |
| 5 | 50 | 50 | 0.3 |
| 6 | 40 | 60 | 0.2 |
| 7 | 30 | 70 | 0.128 |
| 8 | 20 | 80 | 0.075 |
| 9 | 10 | 90 | 0.033 |
| 10 | 5 | 95 | 0.016 |

Compositions 1-10 may be diluted in water or a saline solution before use of the compositions to treat a waste stream. Accordingly, Compositions 1-10 may be present in a treatment solution or waste stream in an amount ranging from 0.25 to about 10 wt. % based on use of LAS (30 wt. % active) and Surfactant (100 wt. % active). For example, treatment compositions according to Compositions 1-10 containing SLS (30 wt. % active) and a surfactant having an HLB of from 1 to less than 5 (100 wt. % active) may be combined as shown in the following table to provide effective amounts of active ingredients in a waste treatment stream or treatment solution wherein the composition ranges from 0.25 to 10 wt. % of the waste treatment stream or treatment solution. In the table, all weights are in grams of ingredients.

TABLE 2
Composition Formulations Component gram weight additions for each total Solution
Concentration Level Percentage

| | 0.25% | | 0.50% | | 1.00% | | 2.00% | |
|---|---|---|---|---|---|---|---|---|
| | SLS, 30 wt. % | | SLS, 30 wt. % | HLB-1 | SLS, 30 wt. % | HLB-1 | SLS, 30 wt. % | HLB-1 |
| Comp. | active | HLB-1 | active | to <5 | active | to <5 | active | to <5 |
| 1 | 1.0215 | 0.1135 | 2.0430 | 0.2270 | 4.0860 | 0.4540 | 8.1720 | 0.9080 |
| 2 | 0.9080 | 0.2270 | 1.8160 | 0.4540 | 3.6320 | 0.9080 | 7.2640 | 1.8160 |
| 3 | 0.7945 | 0.3405 | 1.5890 | 0.6810 | 3.1780 | 1.3620 | 6.3560 | 2.7240 |
| 4 | 0.6810 | 0.4540 | 1.3620 | 0.9080 | 2.7240 | 1.8160 | 5.4480 | 3.6320 |
| 5 | 0.5675 | 0.5675 | 1.1350 | 1.1350 | 2.2700 | 2.2700 | 4.5400 | 4.5400 |
| 6 | 0.4540 | 0.6810 | 0.9080 | 1.3620 | 1.8160 | 2.7240 | 3.6320 | 5.4480 |
| 7 | 0.3405 | 0.7945 | 0.6810 | 1.5890 | 1.3620 | 3.1780 | 2.7240 | 6.3560 |
| 8 | 0.2270 | 0.9080 | 0.4540 | 1.8160 | 0.9080 | 3.6320 | 1.8160 | 7.2640 |
| 9 | 0.1135 | 1.0215 | 0.2270 | 2.0430 | 0.4540 | 4.0860 | 0.9080 | 8.1720 |
| 10 | 0.0568 | 1.0783 | 0.1135 | 2.1565 | 0.2270 | 4.3130 | 0.4540 | 8.6260 |
| | 4.00% | | 6.00% | | 8.00% | | 10.00% | |
| | SLS, 30 wt. % | HLB-1 | SLS, 30 wt. % | HLB-1 | SLS, 30 wt. % | HLB-1 | SLS, 30 wt. % | HLB-1 |
| Comp. | active | to <5 | active | to <5 | active | to <5 | active | to <5 |
| 1 | 16.3440 | 1.8160 | 24.5160 | 2.7240 | 32.6880 | 3.6320 | 40.8600 | 4.5400 |
| 2 | 14.5280 | 3.6320 | 21.7920 | 5.4480 | 29.0560 | 7.2640 | 36.3200 | 9.0800 |
| 3 | 12.7120 | 5.4480 | 19.0680 | 8.1720 | 25.4240 | 10.8960 | 31.7800 | 13.6200 |
| 4 | 10.8960 | 7.2640 | 16.3440 | 10.8960 | 21.7920 | 14.5280 | 27.2400 | 18.1600 |
| 5 | 9.0800 | 9.0800 | 13.6200 | 13.6200 | 18.1600 | 18.1600 | 22.7000 | 22.7000 |
| 6 | 7.2640 | 10.8960 | 10.8960 | 16.3440 | 14.5280 | 21.7920 | 18.1600 | 27.2400 |
| 7 | 5.4480 | 12.7120 | 8.1720 | 19.0680 | 10.8960 | 25.4240 | 13.6200 | 31.7800 |
| 8 | 3.6320 | 14.5280 | 5.4480 | 21.7920 | 7.2640 | 29.0560 | 9.0800 | 36.3200 |
| 9 | 1.8160 | 16.3440 | 2.7240 | 24.5160 | 3.6320 | 32.6880 | 4.5400 | 40.8600 |
| 10 | 0.9080 | 17.2520 | 1.3620 | 25.8780 | 1.8160 | 34.5040 | 2.2700 | 43.1300 |

With regard to Table 2, generally useful compositions for a wide variety of applications may fall within Compositions 3-5 over a range of dilution of 0.25 to 10% by weight. Other useful compositions for relatively low lipid concentrations may fall within Compositions 8-10 over a range of dilution of 0.25 to 10% by weight. The actual weight percent of active ingredient on 100 wt. % basis for each of the formulations shown in Table 2 may be determined by multiplying the amount of SLS by 0.30, adding the amount of surfactant and dividing the sum by the total weight of SLS, surfactant, and diluent.

With reference to the drawings, a particularly useful application of the compositions described herein is for pretreating a waste stream flowing into a receiving chamber of a fluid medical waste treatment system. Such chambers typically have vertical and horizontal surfaces that have an affinity for bio-film formation as described above. Such chamber surfaces may be made of metal and/or polymeric materials such as acrylics, polypropylene, polyethylene, polystyrene, and the like.

However, the cleaning compositions have limited efficacy in removing lipid and protein components that have adhered to the vertical and horizontal surfaces. Accordingly, after a short period of time, bio-film formations on the wetted contact surfaces nurture entrained pathogenic infectives and toxic pharmacological compound residues capable of producing noxious odors.

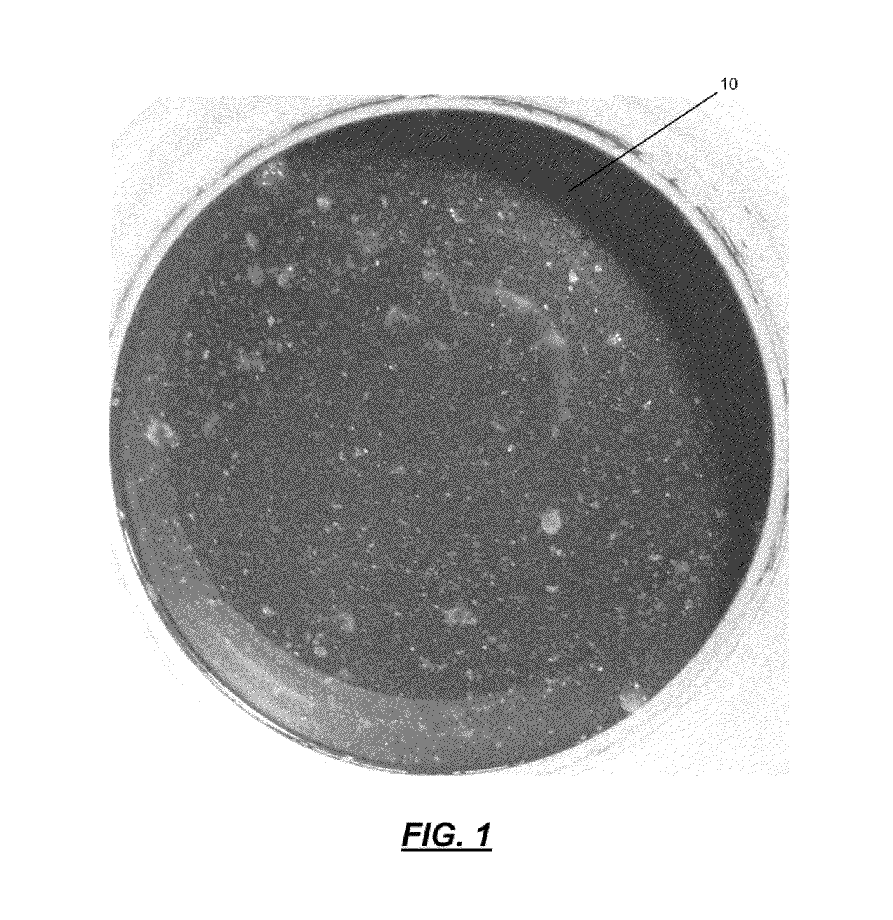

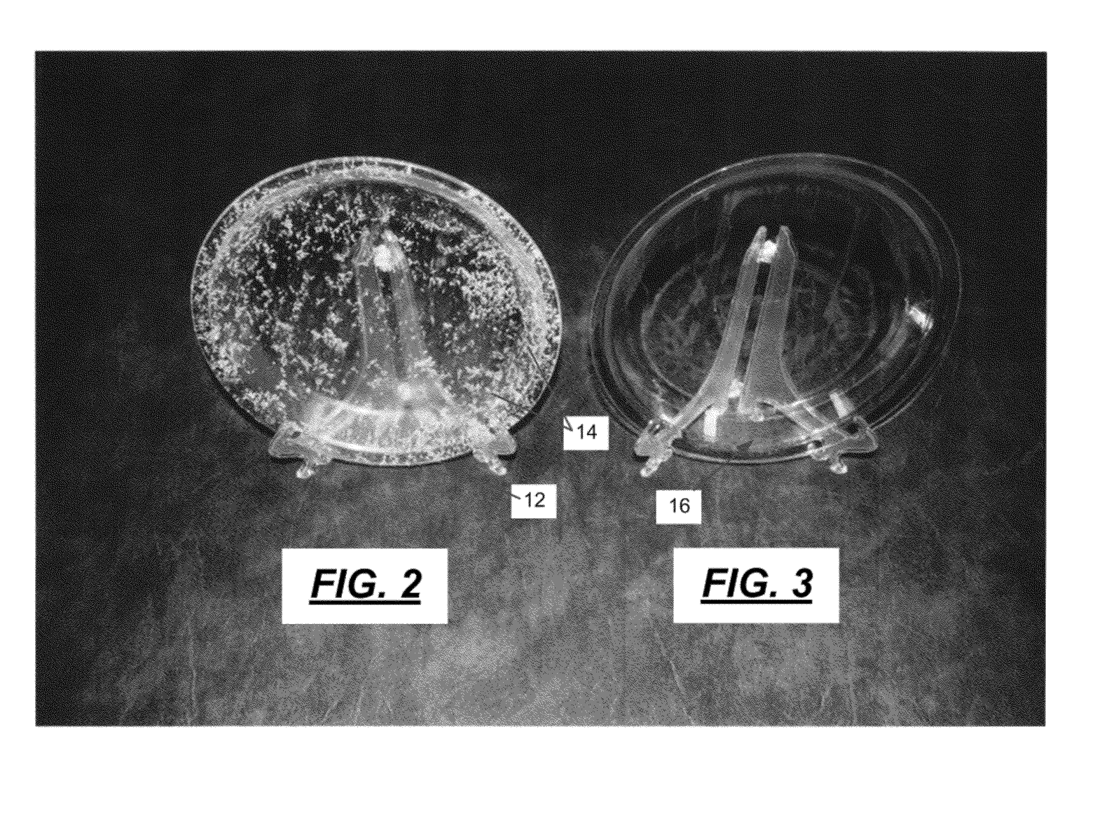

In order to demonstrate the effect of the pretreatment conditioning solution on a typical waste stream, a simulated waste stream containing blood, lipids and protein components 10 (FIG. 1) was provided. A glass plate 12 was dipped into the simulated waste stream 10 prior to pretreating the waste stream with a treatment composition according to embodiments of the disclosure. After a fifteen second immersion, the plate 12 had accumulated lipid components 14 on the surface thereof as shown in FIG. 2.

Next, the simulated waste stream 10 was injected and thoroughly mixed with a pretreatment conditioning composition at a concentration of 2 wt. % (100 wt. % active ingredient basis) containing 0.6 parts of SLS (100 wt. % active) per part of surfactant having an HLB of 1. A clean plate 16 was dipped into the pretreated waste stream for the same amount of time and, as shown in FIG. 3 no accumulation of lipid components was evident on the plate. The result was surprising and totally unexpected.

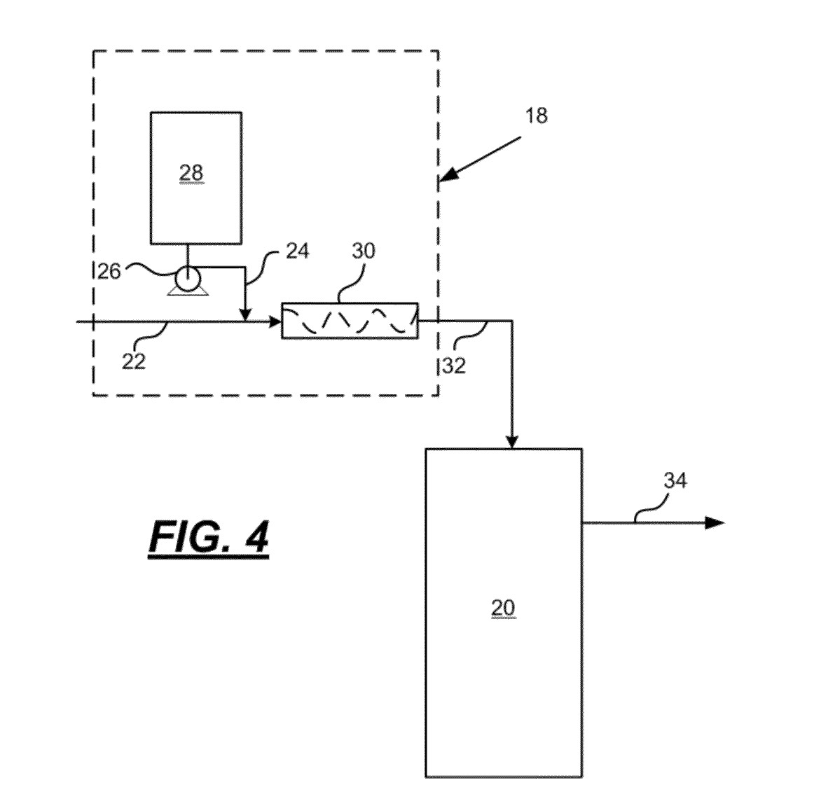

FIG. 4 is a schematic block diagram of a pretreatment conditioner system 18 (indicated by the dotted lines) for the receiving chamber 20 of a fluid medical waste treatment system for collecting a fluid flowing medical waste stream 22 from an operating room. According to an embodiment of the disclosure, a composition 24 containing a lipid agglomeration inhibitor solution and a surfactant as set forth above is metered, injected, or sprayed into the flowing waste stream 22 by a pump 26 from a storage vessel 28 containing the composition. An in-line mixer 30 or other means is used for turbulently mixing the composition 24 with the waste stream 22 before the pretreated waste stream 32 flows into the receiving chamber 20. The receiving chamber 20 then discharges a liquid stream 34 to a subsequent waste processing system. As described herein, the composition 24 is effective for preventing the agglomeration of lipid and/or protein components on the inside surfaces of the fluid medical waste stream treatment system receiving chamber 20 and other wetted fluid flow contact surfaces in the treatment system in addition to the receiving chamber 20.

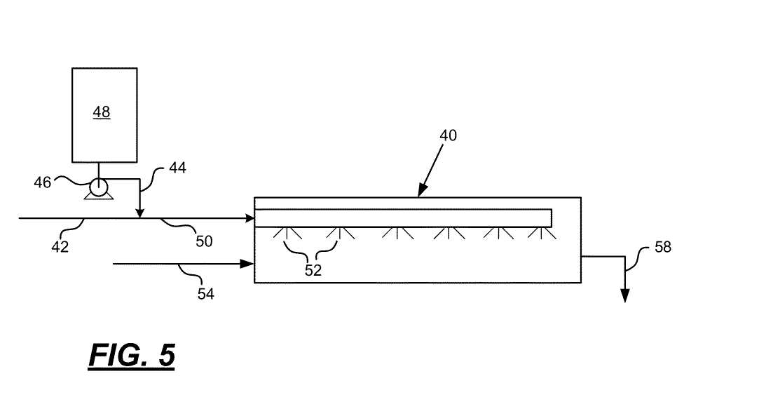

FIG. 5 is a schematic diagram of an alternative injection system for a pretreatment conditioner system 40. In FIG. 5, a flowing fluid stream 42 which may be water is injected with a pretreatment and conditioning concentrate 44 by use of a metering pump 46 from a storage vessel 48 for the concentrate. The pretreated and conditioned stream 50 is then sprayed under turbulent conditions through spray nozzles 52 into a waste stream 54 flowing through a conduit as an alternative injection method by which the pretreatment and conditioning stream is homogeneously mixed with the waste material in the waste stream 54. A conditioned waste stream 58 may then be collected in the receiving chamber 20 (FIG. 4) for further processing in a treatment system. The concentrate 44 and water 42 are effective to reduce foaming in the spray pretreatment conditioner system 40.

It is contemplated, and will be apparent to those skilled in the art from the preceding description that modifications and/or changes may be made in the embodiments of the disclosure. Accordingly, it is expressly intended that the foregoing description is illustrative of exemplary embodiments only, not limiting thereto, and that the true spirit and scope of the present disclosure be determined by reference to the appended claims.

1. A medical waste pretreatment and/or conditioning composition comprising a lipid agglomeration inhibitor and a surfactant having an HLB value ranging from about 1 to less than about 5, wherein a weight ratio of agglomeration inhibitor to surfactant on 100 wt. % active ingredient basis ranges from about 0.015:1 to about 3:1.

2. The composition of claim 1, wherein the agglomeration inhibitor comprises a compound selected from the group consisting of sodium lauryl sulfate, sodium lauryl ether sulfate, ammonium lauryl sulfate, ammonium lauryl ether sulfate, sophorose biosurfactant, sodium lauroyl sarcosinate, triethanolamine lauroyl-L-glutamate, sodium myristyl sarcosinate, sodium dodecyl sulfate, potassium laurate, sodium dodecane sulfonates, and sodium lauryl ethoxysulfate.

4. The composition of claim 1, further comprising a dye.

5. The composition of claim 1, further comprising water.

6. The composition of claim 1, wherein the weight ratio of agglomeration inhibitor to surfactant in the composition on 100 wt. % active ingredient basis ranges from about 0.1:1 to about 0.5:1.

7. The composition of claim 1, wherein the surfactant comprises a polyether polyol non-ionic surfactant having an HLB value ranging from about 1 to about 3.

8. The composition of claim 1, wherein the agglomeration inhibitor comprises sodium lauryl sulfate.

9. A method for pretreating a medical waste stream on a batch or continuous basis comprising:
injecting into the waste stream a composition comprising a lipid agglomeration inhibitor and a surfactant having an HLB value ranging from about 1 to less than about 5, wherein a weight ratio of agglomeration inhibitor to surfactant on 100 wt. % active ingredient basis ranges from about 0.015:1 to about 3:1; and
turbulently mixing the composition and waste stream,
wherein an amount of composition injected into the waste stream is an amount sufficient to provide from about 0.1 to about 9 weight percent of composition to the waste stream based on a total weight of composition and waste stream.

10. The method of claim 9, wherein the agglomeration inhibitor comprises a compound selected from the group consisting of sodium lauryl sulfate, sodium lauryl ether sulfate, ammonium lauryl sulfate, ammonium lauryl ether sulfate, sophorose biosurfactant, sodium lauroyl sarcosinate, triethanolamine lauroyl-L-glutamate, sodium myristyl sarcosinate, sodium dodecyl sulfate, potassium laurate, sodium dodecane sulfonates, and sodium lauryl ethoxysulfate.

11. The method of claim 9, wherein the weight ratio of agglomeration inhibitor to surfactant in the composition on 100 wt. % active ingredient basis ranges from about 0.1:1 to about 0.5:1.

12. The method of claim 9 wherein the surfactant comprises a polyether polyol non-ionic surfactant having an HLB value ranging from about 1 to about 3.

13. The method of claim 9, wherein the amount of composition injected into the waste stream ranges from about 0.1 to about 7 weight percent of composition in the waste stream to be pretreated based on a total weight of composition and waste stream.

14. A method for pretreating or conditioning a surface contaminated with medical waste comprising:
injecting into a fluid flowing stream a cleaning composition comprising a lipid agglomeration inhibitor and a surfactant having an HLB value ranging from about 1 to less than about 5 to provide a pretreatment stream, wherein a weight ratio of agglomeration inhibitor to surfactant on 100 wt. % active ingredient basis ranges from about 0.015:1 to about 3:1; and
spraying the pretreatment composition through spray nozzles into a flowing waste stream to provide turbulent mixing of the composition and waste stream.

15. The method of claim 14, wherein the agglomeration inhibitor comprises a composition selected from the group consisting of sodium lauryl sulfate, sodium lauryl ether sulfate, ammonium lauryl sulfate, ammonium lauryl ether sulfate, sophorose biosurfactant, sodium lauroyl sarcosinate, triethanolamine lauroyl-L-glutamate, sodium myristyl sarcosinate, sodium dodecyl sulfate, potassium laurate, sodium dodecane sulfonates, and sodium lauryl ethoxysulfate.

16. The method of claim 14, wherein the weight ratio of agglomeration inhibitor to surfactant in the composition on 100 wt. % active ingredient basis ranges from about 0.1:1 to about 0.5:1.

17. The method of claim 14 wherein the surfactant comprises a polyether polyol non-ionic surfactant having an HLB value ranging from about 1 to about 3.
